(19) United States
(12) Patent Application Publication
(10) Pub. No.: US 2012/0020696 A1
(43) Pub. Date: Jan. 26, 2012

(54) FIXING DEVICE AND IMAGE FORMING APPARATUS

(76) Inventors: Hiroshi KON, Yokohama-shi (JP); Hideki SATO, Yokohama-shi (JP); Jun SAWAMURA, Yokohama-shi (JP)

(21) Appl. No.: 13/027,593

(22) Filed: Feb. 15, 2011

(30) Foreign Application Priority Data
Jul. 26, 2010 (JP) 2010-166917

(51) Int. Cl. G03G 15/00; G03G 15/20

(52) U.S. Cl. 399/90; 399/330

(57) ABSTRACT

A fixing device includes: a fixing device main body; a heating member that is installed in the fixing device main body and heats a developer image transferred to a recording medium; and a power line that supplies power to the heating member, the fixing device main body including a first retaining part and a second retaining part formed following the first retaining part, and the heating member being retained by the first retaining part and the power line being retained by the second retaining part.

### CROSS-REFERENCE TO RELATED APPLICATION

This application is based on and claims priority under 35 USC 119 from Japanese Patent Application No. 2010-166917 filed Jul. 26, 2010.

### BACKGROUND

### Technical Field

The present invention relates to a fixing device and an image forming apparatus.

### SUMMARY

According to an aspect of the present invention, there is provided a fixing device including a fixing device main body, a heating member that is installed in the fixing device main body and heats a developer image transferred to a recording medium, and a power line that supplies power to the heating member, the fixing device main body including a first retaining part and a second retaining part formed following the first retaining part, and the heating member being retained by the first retaining part and the power line being retained by the second retaining part.

### BRIEF DESCRIPTION OF THE DRAWINGS

Exemplary embodiments of the present invention will be described in detail based on the following figures, wherein:

FIG. 1 is a cross-sectional diagram depicting an image forming apparatus pertaining to an exemplary embodiment of the present invention;

FIG. 2 is a cross-sectional diagram outlining a configuration of a fixing device pertaining to an exemplary embodiment of the present invention;

FIGS. 3A and 3B depict a state in which a heating roller is installed in a fixing device main body of the fixing device pertaining to an exemplary embodiment of the present invention, wherein FIG. 3A is a top view when viewed from a direction in which the heating roller is installed and FIG. 3B is a top view when viewed from the reverse side to FIG. 3A

FIGS. 4A and 4B are enlarged views depicting one end and its vicinity of the heating roller in the fixing device shown in FIGS. 3A and 3B, wherein FIG. 4A is a top view and FIG. 4B is a side view;

FIG. 5 is a diagram to explain harness wiring from the heating roller shown in FIGS. 3A and 3B; and

FIGS. 6A and 6B are enlarged views depicting one end and its vicinity of a heating roller in a fixing device pertaining to another exemplary embodiment, wherein FIG. 6A is a top view and a FIG. 6B is a side view.

### DETAILED DESCRIPTION

In the following, exemplary embodiments of the present invention will be described, based on the drawings.

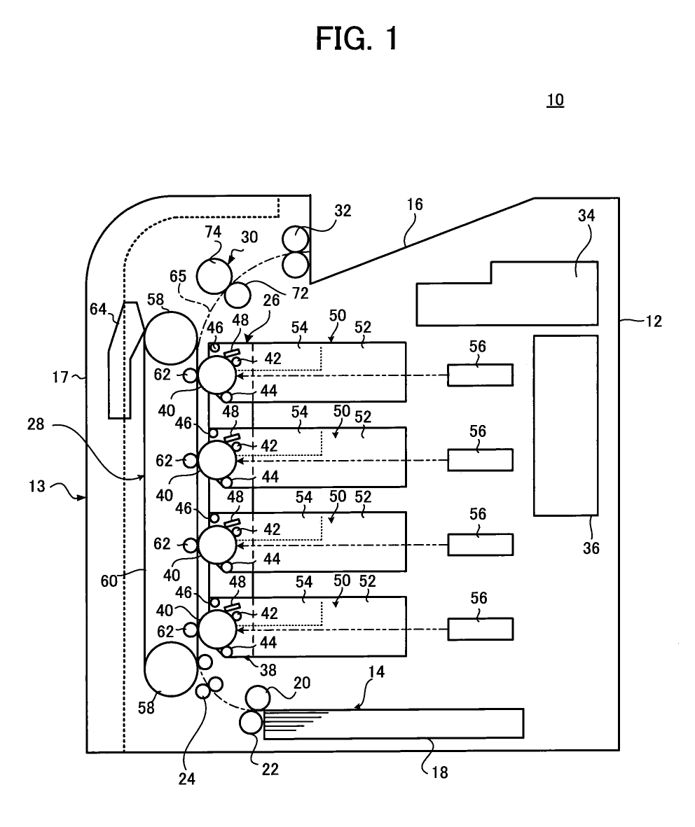

FIG. 1 depicts an image forming apparatus 10 pertaining to an exemplary embodiment of the present invention. The image forming apparatus 10 has an image forming apparatus main body 12. A sheet feeder 14 is disposed at the bottom of the image forming apparatus main body 12 and a sheet collector 16 is formed on the top of the image forming apparatus main body 12.

In the front (left side in FIG. 1) of the image forming apparatus main body 12, an opening and closing device 13 is provided. The opening and closing device 13 includes an opening and closing cover 17 as an opening and closing unit that opens and closes the image forming apparatus main body 12.

The sheet feeder 14 includes a sheet container 18 and a lot of sheets are stacked in the sheet container 18. A feed roller 20 that comes in contact with stacked sheets is located just above the top of one end of the sheet container 18 and a retard roller 22 is located so as to face and abut on the feed roller 20. A top sheet from the sheet stack in the sheet container 18 is picked up by the feed roller 20 and the sheet is separated from the sheet stack and transported by cooperation of the feed roller 20 and the retard roller 22.

The sheet transported from the sheet container 18 is temporarily stopped by registration rollers 24 and moved at a predetermined timing to pass between a photoreceptor unit 26 and a belt unit 28 which will be described later and through a fixing device 30 and, eventually, ejected by eject rollers 32 to the sheet collector 16.

Inside the image forming apparatus main body 12, the photoreceptor unit 26 which is an example of an image forming structure, the belt unit 28, a power supply unit 34, and a controller 36 are disposed.

The photoreceptor unit 26 is configured such that four photoreceptors 40 which are examples of image carriers are rotatably supported by a photo receptor unit main body 38 which is an example of an image carrier supporting member. In the periphery of each of the photoreceptors 40, the photoreceptor unit 26 includes the following: a charging device 42 as a charging unit equipped with a charging roller that evenly charges the photoreceptor 40, a development device 44 as a development unit that visualizes an electrostatic latent image projected onto each of the photoreceptors 40 by developing with developer including toner, a neutralization device 46 that neutralizes and eliminates static electricity from the photoreceptor 40 after transfer, and a toner removal device 48 formed of a cleaning blade or the like that removes toner remaining on the surface of the photoreceptor 40 after transfer is done.

The photoreceptor unit 26 is an assembly of the four photoreceptors 40 and their associated charging devices 42, development devices 44, neutralization devices 46, and toner removal devices 48 and removably installed in the image forming apparatus main body 12.

The power supply unit 34 is disposed in an upper portion of the image forming apparatus main body 12 and adapted to supply power to the above-mentioned sheet feeder 14, belt unit 28, charging devices 42, development devices 44, etc.

Four toner boxes 50 are connected laterally in the rear of the photoreceptor unit 26. The toner boxes 50 are for magenta, yellow, cyan, and black and each toner box is an assembly of a toner supply section 52 and a toner collecting section 54.

The toner supply section 52 is connected to the development device 44 to supply toner of each color to the development device 44. The toner collecting section 54 is connected to the toner removal device 48 to collect toner of each color.

Optical projection devices 56, each formed of a laser illuminator, are located in the back of the photoreceptor unit 26 in positions corresponding to the photoreceptors 40. Each of the optical projection devices 56 is adapted to irradiate the evenly charged surface of the photoreceptor 40 with laser, thus forming a latent image on the surface of the photoreceptor 40.

The belt unit 28 is located in the front of the photoreceptor unit 26 and disposed in a vertical direction, facing the photoreceptor unit 26. The belt unit 28 is provided with two support rollers 58 disposed in up and down positions and a transport belt 60 extending between the two support rollers 58 in a tensioned state.

The transport belt 60 is adapted to transport a sheet having a toner image transferred to it. Transfer rollers 62 are also provided so as to face and abut on each of the photoreceptors 40, so that the transport belt 60 passes between each transfer roller and each photoreceptor.

A cleaning device 64 is disposed in the front of the belt unit 28 and located to face and abut on the belt unit 28. The cleaning device 64 is adapted to eliminate extraneous matters such as toner particles and paper powders from the surface of the transport belt 60.

Hence, each of the photoreceptors 40 is evenly charged by the charging device 42, a latent image is formed on its surface by the optical projection device 56, and the latent image is visualized by the development device 44. Toner images thus formed on the surface of each of the photoreceptors 40 are transferred sequentially to a sheet being transported on the belt unit 28 by the transfer rollers 62 arranged along the belt unit 28 and fixed onto the sheet by the fixing device 30.

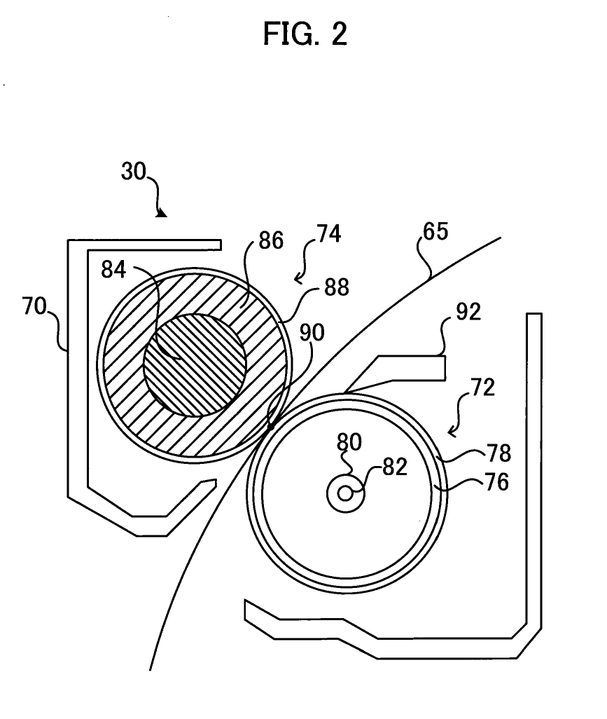

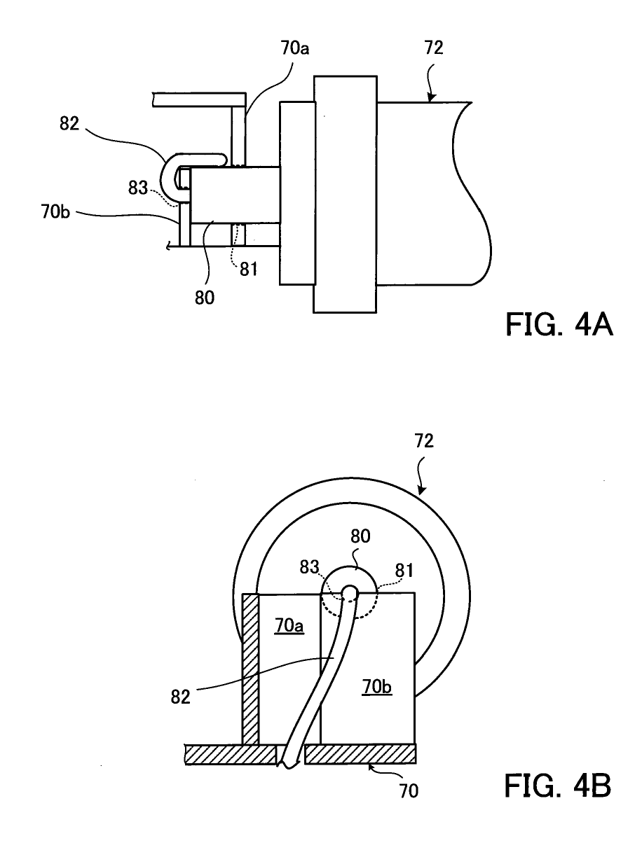

In FIGS. 2 through 5, a configuration of the fixing device 30 is illustrated. The fixing device 30, which is configured as a single unit, has a fixing device main body 70 and includes a heating roller 72 and a pressure roller 74 inside the fixing device main body 70.

The heating roller 72 includes a cylindrical core 76 and a release layer 78 coating the surface of the core 76. The core 76 is, for example, 35 mm or less in diameter and 350 mm or more in length and may be made from, inter alia, 0.1 mm thick iron or 0.5 mm thick aluminum. The release layer 78 is formed of an insulating material, for example, insulating perfluoroalkoxy (PFA) and its thickness may fall, for example, between 30 and 100 μm.

Inside the heating roller 72, a heater 80 which is a heating member is disposed. The heater 80 is configured with a glass tube wrapped with a nichrome wire. To an end portion of the heater 80, a harness 82 which is a power line to supply power to the heater 80 is connected. According to control of the controller 36, the harness 82 supplies the heater 80 with power for heating the heating roller 72.

One frame extending along a diametrical direction of the fixing device main body 70 is provided with a first plate-shaped retaining part 70a and a second plate-shaped retaining part 70b which is formed following the first retaining part 70a and substantially in parallel with the first retaining part 70a.

The first retaining part 70a is provided with a concave portion 81 in which the end portion of the heater 80 is fit. The end portion of the cylindrically-shaped heater 80 is fixed in this concave portion 81.

The second retaining part 70b is provided with a concave portion 83 in which the harness 82 is fit. The harness 82 connector making connection to the heater 80 and its vicinity are fixed in this concave portion 83.

On the reverse side of the fixing device main body 70 to a direction in which the heater 80 is installed, multiple third retaining parts 70c are provided to retain the harness 82.

The end portion of the heater 80 in a longitudinal direction hits against the lateral face of the second retaining part 70b and the heater 80 is thus positioned in the longitudinal direction.

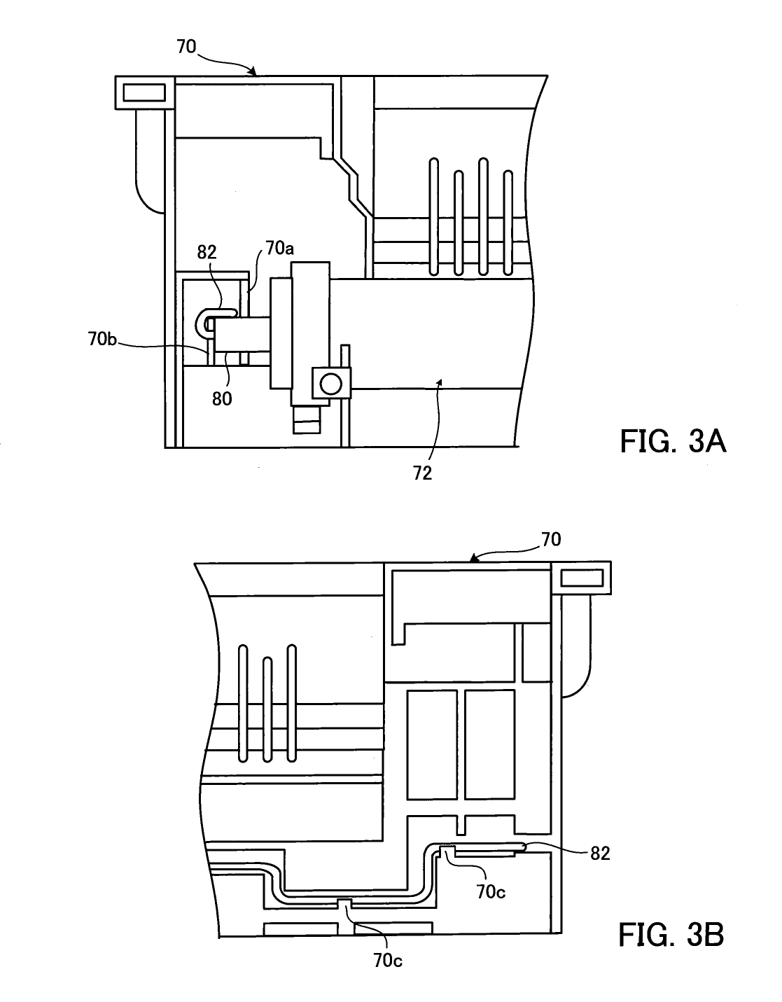

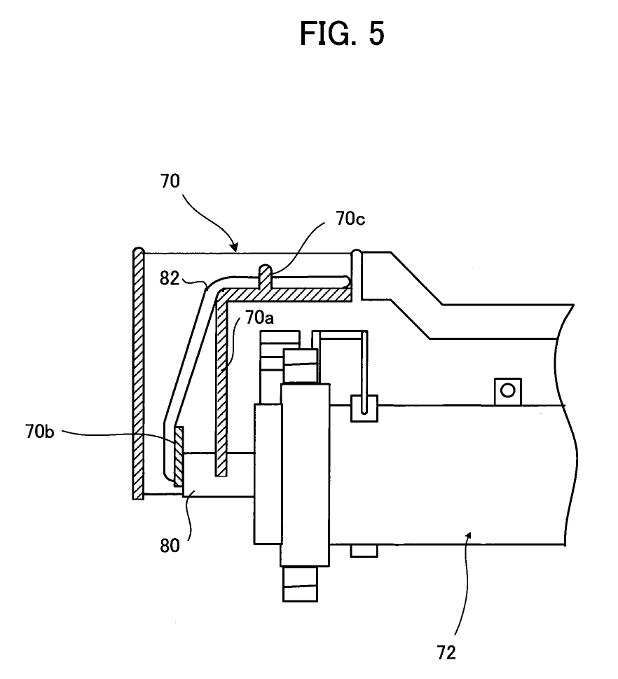

Specifically, as is shown in FIG. 3A, the heater 80 is retained in the concave portion 81 of the first retaining part 70a, while the harness 82 is retained in the concave portion 83 of the second retaining part 70b. In this state, the harness is routed to the reverse side of the fixing device main body 70, as is shown in FIG. 3B, and pulled downward and retained by the third retaining parts 70c provided on the fixing device main body 70, as is shown in FIG. 5. In this way, the heater 80 is positioned, with the harness 82 being bent at least twice.

When installing the heater 80, the heater is positioned by pulling and routing the harness 82 to fit it in the concave portion 83 and bending and routing the harness 82 to the reverse side of the fixing device main body 70. In addition, the heater is firmly positioned by having the harness retained by the third retaining parts 70c. Here, the harness 82 is provided with a thick sheath layer in order to shield it from heat generated by the heater 80 and the flexural rigidity of the harness 82 is high (so to speak, the harness is “flexible”). Therefore, the heater is firmly positioned, taking advantage of this “flexibility” of the harness.

The pressure roller 74 includes a rotary shaft 84 which is made from, for example, inter alia, stainless material or iron, a heat-resistant elastic body layer 86 which rotates with the rotary shaft 84 and is made from, inter alia, silicon sponge (Asker C hardness of 45) with a thickness, for example, between 6 and 8 mm, a covering layer 88 which covers the surface of the heat-resistant elastic body layer 86. The covering layer 88 is made from an electrically conductive material, for example, electrically conductive PFA, and its thickness may fall, for example, between 30 and 100 μm. The pressure roller 74 is pressed against the heating roller 72 by an elastic member such as a spring, which is not shown, via an arm, which is not shown, and turns, driven by the rotary motion of the heating roller 72.

The heating roller 72 and the pressure roller 74 constitute a fixing unit that fuses and fixes a developer image which has been transferred to a recording member passing through a nip 90 between them by heat and pressure. A transport path 65 is configured to vertically extend across the nip 90, so that a recording medium coming from underneath is transported upward. A separator pawl 92 is provided near the transport path downstream of the nip 90. The separator pawl 92 is urged against the heating roller 72 by weak force so as not to damage the surface of the against heating roller 72, so that the tip of the separator pawl 92 is pressed against the surface of the heating roller 72, thus separating a recording medium that tends to wrap around the heating roller 72 from the heating roller 72.

Then, a fixing device 30 pertaining to another exemplary embodiment is described.

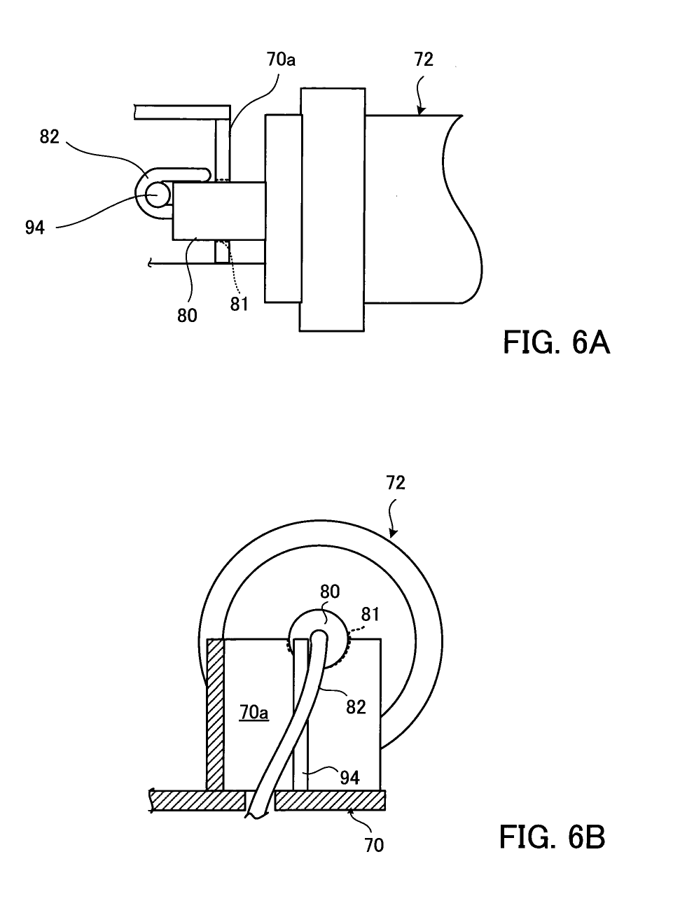

FIGS. 6A and 6B depict one end and its vicinity of the heating roller 72 in the fixing device 30 pertaining to another exemplary embodiment.

In the fixing device 30 pertaining to another exemplary embodiment, instead of the second retaining part 70b provided on the frame extending along the diametrical direction of the fixing device main body 70, a retaining part 94 is used that erects along the diametrical direction with respect to the heater 80 as an anchor to fasten the harness 82. The retaining part 94 made in, for example, inter alia, a columnar form or a cylindrical form may be used. The retaining part 94 is located adjacent to the heater 80 at which the harness 82 is connected to the heater and substantially perpendicular to the heating roller 72. It erects along the diametrical direction with respect to the heater 80, so that the harness 82 is fastened by it.

That is, the heater 80 is fit in the concave portion 81 of the first retaining part 70a, while the harness 82 is fastened by the retaining part 94 erecting along the diametrical direction with respect to the heater 80. The harness 82 is then routed to the reverse side of the fixing device main body 70, pulled downward, and fastened by the third retaining parts 70c provided in the longitudinal direction of the fixing device main body 70.

The retaining part to hold the harness is not limited to the above-mentioned form and may be made in any other form as long as it can fasten the harness 82.

As described hereinbefore, the present invention can be applied to image forming apparatus such as, e.g., copiers, printers, and facsimile machines.

The present invention may be embodied in other specific forms without departing from its spirit or essential characteristics. The described exemplary embodiments are to be considered in all respects only as illustrated and not restrictive. The scope of the present invention is, therefore, indicated by the appended claims rather than by the foregoing description. All changes which come within the meaning and range of equivalency of the claims are to be embraced within their scope.

What is claimed is:

1. A fixing device comprising:
a fixing device main body;
a heating member that is installed in the fixing device main body and heats a developer image transferred to a recording medium; and
a power line that supplies power to the heating member,
the fixing device main body including a first retaining part and a second retaining part formed following the first retaining part, and
the heating member being retained by the first retaining part and the power line being retained by the second retaining part.

2. The fixing device according to claim 1, wherein the second retaining part is provided along a diametrical direction with respect to the heating member and includes a concave portion in which the power line is fit.

3. The fixing device according to claim 1, wherein the second retaining part is configured to erect along the diametrical direction with respect to the heating member as an anchor to fasten the power line.

4. The fixing device according to claim 1, wherein the heating member is positioned in a longitudinal direction of the heating member by hitting against the second retaining part.

5. The fixing device according to claim 1, wherein the fixing device main body includes third retaining parts to retain the power line on a reverse side of the fixing device main body relative to the installation position of the heating member.

6. The fixing device according to claim 5, wherein the power line is bent at least twice by the second retaining part and the third retaining parts.

7. An image forming apparatus comprising:
an image forming part that forms an image; and
a fixing device that fixes an image formed by the image forming part onto a recording medium,
the fixing device including:
a fixing device main body;
a heating member that is installed in the fixing device main body and heats a developer image transferred to a recording medium; and
a power line that supplies power to the heating member,
the fixing device main body including a first retaining part and a second retaining part formed following the first retaining part, and
the heating member being retained by the first retaining part and the power line being retained by the second retaining part.
